(19) United States
(12) Patent Application Publication
(10) Pub. No.: US 2014/0295326 A1
(43) Pub. Date: Oct. 2, 2014

(54) NITROGEN-DOPED TUNGSTEN CARBIDE STRUCTURE AND METHOD OF PREPARING THE SAME

(71) Applicant: Intellectual Discovery Co., Ltd., Seoul (KR)

(72) Inventors: Kyung-Won PARK, Seoul (KR); Je-Suk MOON, Jeju-si (KR); Young-Woo LEE, Seoul (KR); Sang-Beom HAN, Incheon (KR); Kyung-Hoon LEE, Pohang-si (KR)

(73) Assignee: Intellectual Discovery Co., Ltd., Seoul (KR)

(21) Appl. No.: 14/228,733

(22) Filed: Mar. 28, 2014

(30) Foreign Application Priority Data
Mar. 29, 2013 (KR) 10-2013-0034883

(51) Int. Cl. H01M 4/90; H01M 4/86; H01M 4/88

(52) U.S. Cl. CPC H01M 4/90; H01M 4/8875; H01M 4/8605; H01M 4/8657
USPC 429/533; 429/535

(57) ABSTRACT

A tungsten carbide structure includes tungsten carbide having a plate shaped structure and including a plurality of mesopores, a first carbon layer surrounding a surface of tungsten carbide and containing nitrogen, and a second carbon layer surrounding the first carbon layer and containing nitrogen.

### CROSS-REFERENCE TO RELATED APPLICATION

This application claims priority to and the benefit of Korean Patent Application No. 10-2013-00348883 filed in the Korean Intellectual Property Office on Mar. 29, 2013, the entire contents of which are incorporated herein by reference.

### BACKGROUND OF THE INVENTION

(a) Field of the Invention

A nitrogen-doped tungsten carbide structure and a method of preparing the same are provided.

(b) Description of the Related Art

A fuel cell is a cell directly converting chemical energy generated by oxidation of fuel such as hydrogen, methanol, natural gas, or the like, into electrical energy. A representative fuel cell is a hydrogen-oxygen fuel cell, and in the hydrogen-oxygen fuel cell, hydrogen gas is supplied to an anode as fuel, and oxygen gas is supplied to a cathode as an oxidant. At the anode of the fuel cell, hydrogen gas is oxidized to thereby form protons and electrons, and at the cathode thereof, oxygen gas is reduced together with protons to form water.

In order to increase a rate of a reduction reaction of oxygen, a platinum catalyst is used in the cathode of the fuel cell. The platinum catalyst has high electric conductivity and excellent catalytic characteristics, but the platinum catalyst is expensive, and it is not easy to increase a surface area of platinum on which a catalyst action occurs. Therefore, there is a need for developing a technology of decreasing a content of platinum or a non-precious metal catalyst, which is an alternative catalyst in order to decrease a cost.

It has been reported that tungsten carbide belonging to transition metal carbides among the non-precious metal catalysts has a catalytic activity due to density of electron states similar to that of platinum. In addition, the tungsten carbide is inexpensive while having high electric conductivity and high stability.

The above information disclosed in this Background section is only for enhancement of understanding of the background of the invention and therefore it may contain information that does not form the prior art that is already known in this country to a person of ordinary skill in the art.

### SUMMARY OF THE INVENTION

In an embodiment, a nitrogen-doped tungsten carbide structure having excellent catalytic activity and an inexpensive price without using a noble metal such as platinum or the like is provided.

An exemplary embodiment provides a tungsten carbide structure including tungsten carbide having a plate shaped structure and including a plurality of mesopores, a first carbon layer surrounding a surface of the tungsten carbide and containing nitrogen, and a second carbon layer surrounding the first carbon layer and containing nitrogen.

The first carbon layer may contain pyridinic-N, graphitic-N, or both of them, and the second carbon layer may contain pyridinic-N, graphitic-N, or both of them.

A content of nitrogen contained in the second carbon layer may be greater than a content of nitrogen contained in the first carbon layer.

The tungsten carbide and the first carbon layer may contact each other.

The surface of the tungsten carbide may include a pair of surfaces vertically opposing each other and a surface forming the mesopore.

An exemplary embodiment provides a method of preparing a tungsten carbide structure including heat treating WO₃H₂O under ammonia gas atmosphere to prepare W₂N, heat treating W₂N under methane gas and hydrogen gas atmospheres to prepare tungsten carbide including a carbon layer, adding the tungsten carbide including the carbon layer and melamine in an organic solvent to form powder, and heat treating the powder under nitrogen atmosphere to prepare a tungsten carbide structure.

The forming of the powder may include stirring and drying.

The preparing of the tungsten carbide structure may be performed at 400 to 800 degrees Celsius.

The tungsten carbide structure may include a plurality of mesopores.

The tungsten carbide structure may include a plurality of carbon layers.

The plurality of carbon layers may contain nitrogen.

According to an exemplary embodiment, the tungsten carbide structure having excellent catalytic activity and an inexpensive price without using a noble metal such as platinum, or the like, may be provided.

### BRIEF DESCRIPTION OF THE DRAWINGS

FIG. 1 is a view showing a method of preparing a nitrogen-doped tungsten carbide catalyst according to an exemplary embodiment of the present invention.

FIG. 2 is a cross-sectional view taken along line A-A of FIG. 1.

FIG. 3 is a view schematically showing a nitrogen-doped carbon layer according to an exemplary embodiment of the present invention.

FIG. 4 is a transmission electron microscope (TEM) photograph of nitrogen-doped tungsten carbide according to an exemplary embodiment of the present invention.

FIG. 5 is a transmission electron microscope (TEM) photograph of nitrogen-doped tungsten carbide according to an exemplary embodiment of the present invention.

FIG. 6 is an X-ray diffraction (XRD) graph of nitrogen-doped tungsten carbide (a) according to an exemplary embodiment of the present invention and tungsten carbide (b) on which a carbon layer is formed.

FIG. 7 is an X-ray photoelectron spectroscopy (XPS) graph of nitrogen-doped tungsten carbide according to an exemplary embodiment of the present invention.

FIG. 8 is an X-ray photoelectron spectroscopy (XPS) graph of nitrogen-doped tungsten carbide according to an exemplary embodiment of the present invention.

FIG. 9 is an oxygen reduction reaction graph of nitrogen-doped tungsten carbide according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification. In addition, the detailed description of the widely known technologies will be omitted.

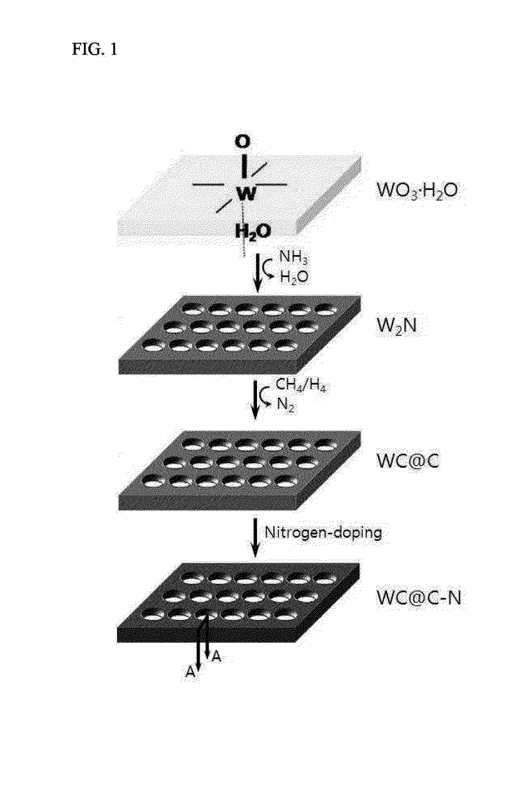

Then, a nitrogen-doped tungsten carbide catalyst according to an exemplary embodiment of the present invention and a method of preparing the same will be described in detail with reference to FIGS. 1 to 9.

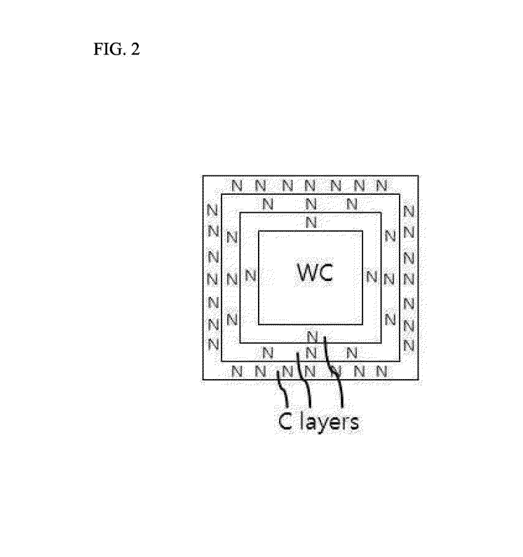

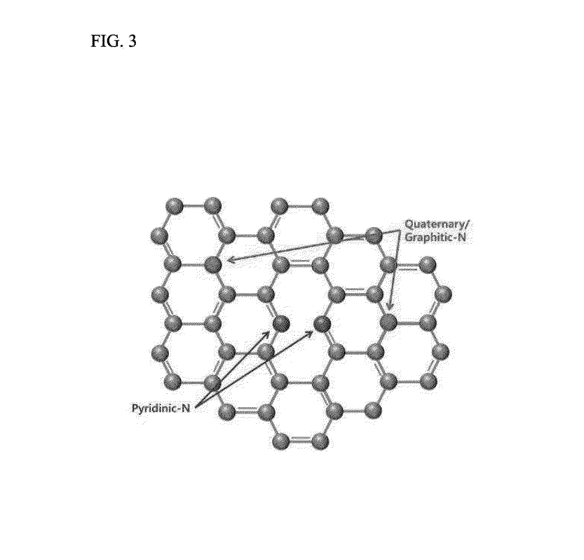

FIG. 1 is a view showing a method of preparing a nitrogen-doped tungsten carbide catalyst according to an exemplary embodiment of the present invention, FIG. 2 is a cross-sectional view taken along line A-A of FIG. 1, and FIG. 3 is a view schematically showing a nitrogen-doped carbon layer according to an exemplary embodiment of the present invention.

Referring to FIG. 1, mesoporous tungsten carbide (WC@C) including a carbon layer formed on a surface thereof and having a plate-shaped structure is doped with nitrogen, thereby preparing a nitrogen-doped tungsten carbide (WC@C—N) having a new structure. The nitrogen-doped tungsten carbide prepared as described above may be used as a catalyst of a cathode of a fuel cell, a material of an oxygen electrode of a lithium air battery, or the like.

First, WO₃H₂O having the plate shaped structure is heat treated under ammonia gas atmosphere, thereby preparing W₂N having a mesoporous structure. W₂N has a plurality of mesopores. For example, the heat treatment may be performed in an electric furnace at about 400 to about 800 degrees Celsius for about 1 to about 15 hours. In this case, a heating rate may be approximately 10 degrees Celsius per minute.

Then, the prepared W₂N is heat treated under methane gas and hydrogen gas atmospheres, thereby preparing tungsten carbide on which a carbon layer is formed. For example, a mixing volume ratio of the methane gas and the hydrogen gas may be approximately 25%:75% and the heat treatment may be performed at about 600 to about 800 degrees Celsius for about 1 hour to about 50 hours. In this case, a heating rate may be approximately 10 degrees Celsius per minute.

Next, the tungsten carbide including the carbon layer and melamine are added to an organic solvent, stirred, and then dried, thereby preparing powder. For example, the organic solvent may be ethanol, the stirring may be performed for about 12 hours using a sonicator and a stirrer, and the drying of the stirred solution may be performed at about 60 degrees Celsius in a vacuum drier.

Then, the prepared powder is heat treated under nitrogen atmosphere, thereby preparing nitrogen-doped tungsten carbide. For example, the heat treatment may be performed in an electric furnace at about 400 to about 800 degrees Celsius for about 1 to about 15 hours. In this case, a heating rate may be approximately 10 degrees Celsius per minute. The nitrogen-doped tungsten carbide includes a plurality of mesopores.

Referring to FIG. 2, the nitrogen-doped tungsten carbide has a cross-sectional structure in which the surface of the tungsten carbide is surrounded by a plurality of carbon layers. Here, the surface of the tungsten carbide may include a pair of surfaces vertically opposing each other and a surface forming the mesopores. In this case, as a distance between the carbon layer and the tungsten carbide is increased, a content of nitrogen in the carbon layer is increased. For example, when the tungsten carbide is sequentially surrounded by a first carbon layer, a second carbon layer, and a third carbon layer, a content of nitrogen in the second carbon layer may be greater than that of nitrogen contained in the first carbon layer, and a content of nitrogen contained in the third carbon layer may be greater than that of nitrogen contained in the second carbon layer.

Referring to FIG. 3, in the nitrogen-doped tungsten carbide pyridinic-N, graphitic-N, or the like, may be formed on the carbon layer containing nitrogen. Pyridinic-N is double-bonded to carbon at one side and single-bonded to carbon at the other side. Graphitic N is single-bonded to each of the three carbons.

Hereinafter, the present invention will be described in detail with reference to Examples, but the following Examples are only examples of the present invention, and the present invention is not limited to the following Examples.

### Preparation of W₂N

When WO₃H₂O was heat treated in an electric furnace under ammonia gas atmosphere at about 700 degrees Celsius for about 3 hours, W₂N was prepared. In this case, a heating rate was approximately 10 degrees Celsius per minute.

### Preparation of WC@C

When the prepared W₂N was heat treated in an electric furnace under methane gas and hydrogen gas atmospheres (about 25%:75%) at about 900 degree Celsius for about 9 hours, WC@C was prepared. In this case, a heating rate was approximately 10 degrees Celsius per minute.

### Preparation of WC@C—N

When prepared WC@C and melamine were added to ethanol, stirred for about 12 hours using a sonicator and a stirrer, and dried in a vacuum drier at about 60 degrees Celsius, powder was formed. When the formed powder was heat treated in an electric furnace under nitrogen atmosphere at about 700 degrees Celsius for about 3 hours, WC@C—N was formed. In this case, a lo heating rate was approximately 10 degrees Celsius per minute.

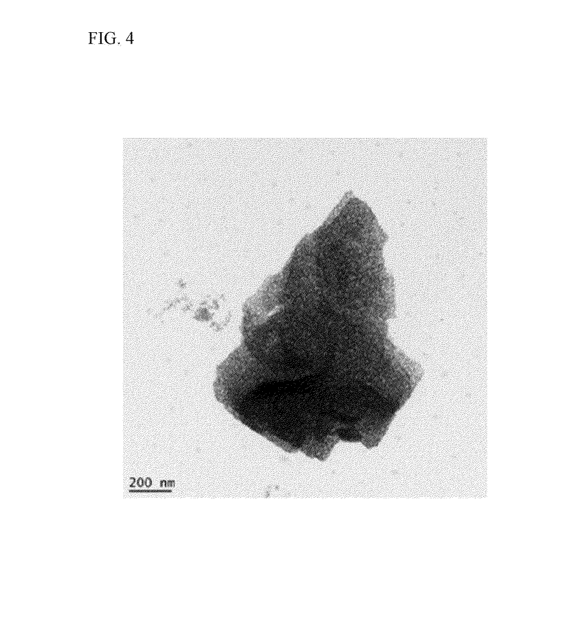

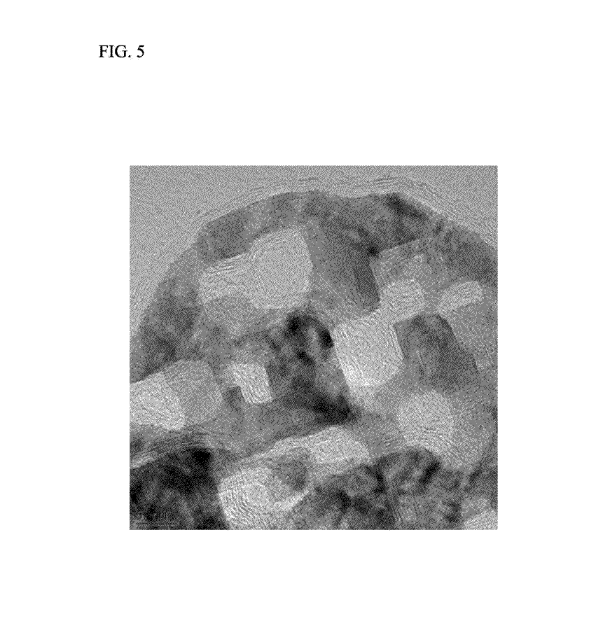

The TEM photographs of the prepared WC@C—N were shown in FIGS. 4 and 5. The TEM photograph of FIG. 4 was photographed at a unit of 200 nm, and the TEM photograph of FIG. 5 was photographed at a unit of 5 nm. Referring to FIG. 5 it may be appreciated that the tungsten carbide had a mesoporous structure and a plurality of carbon layers were formed on the surface of the tungsten carbide.

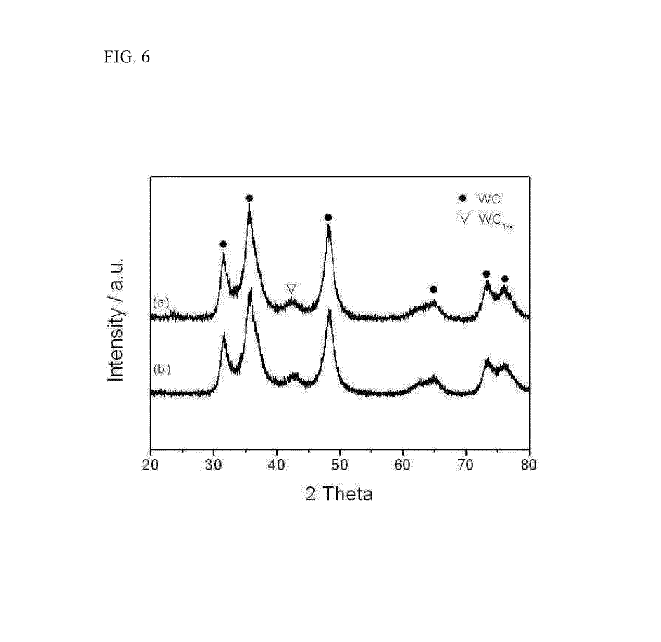

An XRD graph (a) of the prepared WC@C—N and an XRD graph (b) of the prepared WC@C were shown in FIG. 6. Referring to FIG. 6, it may be appreciated that in the WC@C—N and WC@C, a WC phase and a WC₁₋ₓ (0<x<1) phase co-existed, respectively.

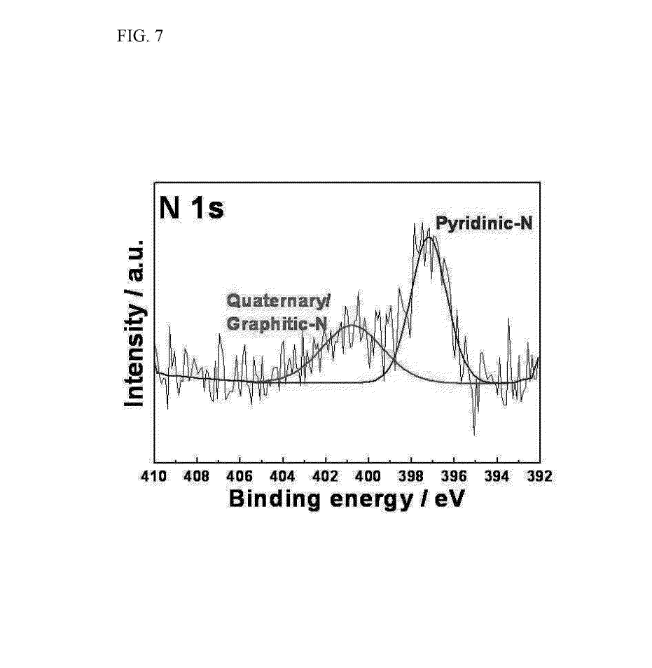

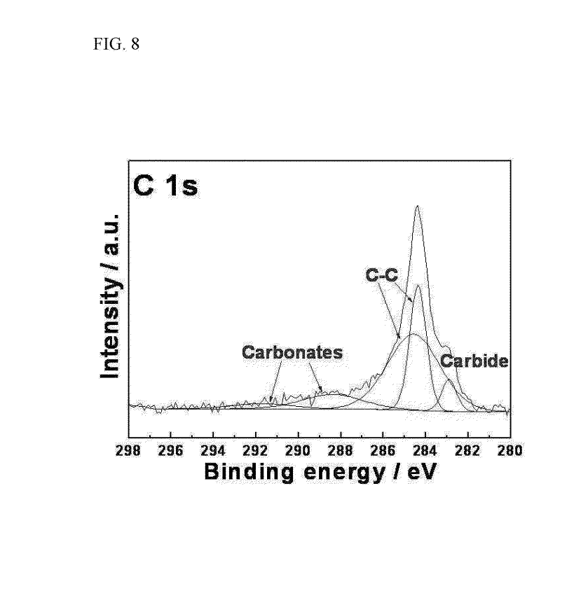

XPS graphs of the prepared WC@C—N were shown in FIGS. 7 and 8. Referring to FIGS. 7 and 8, it may be appreciated that pyridinic-N and graphitic-N were formed in the carbon layer.

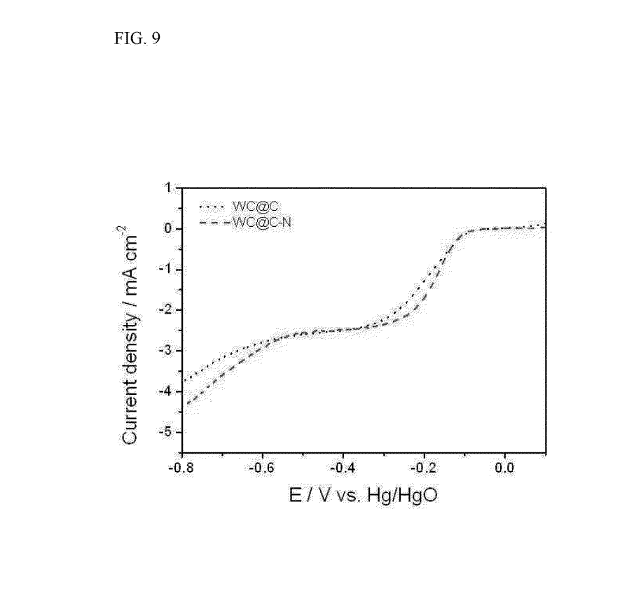

An oxygen reduction reaction graph of the prepared WC@C was shown in FIG. 9. In this case, an oxygen reduction current in an oxygen saturated NaOH solution was measured using rotating disk electrode (RDE) voltammeter at a rotation rate of about 1600 rpm. Referring to FIG. 9, it may be appreciated that reduction of the prepared WC@C—N started at approximately −0.07V, and the prepared WC@C—N had a more excellent property of reaching the limiting current as compared to the prepared WC@C, such that the catalytic activity of the WC@C—N was higher than that of the WC@C.

According to an exemplary embodiment of the present invention, the nitrogen-doped tungsten carbide may perform an oxygen reduction reaction in a basic solution, such that the nitrogen-doped tungsten carbide may be used as a catalyst of a cathode of a fuel cell or a material of an oxygen electrode of a lithium air battery.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A tungsten carbide structure comprising:
tungsten carbide having a plate shaped structure and including a plurality of mesopores,
a first carbon layer surrounding a surface of the tungsten carbide and containing nitrogen, and
a second carbon layer surrounding the first carbon layer and containing nitrogen.

2. The tungsten carbide structure of claim 1, wherein:
the first carbon layer contains pyridinic-N, graphitic-N, or both of them, and the second carbon layer contains pyridinic-N, graphitic-N, or both of them.

3. The tungsten carbide structure of claim 2, wherein:
a content of nitrogen contained in the second carbon layer is greater than a content of nitrogen contained in the first carbon layer.

4. The tungsten carbide structure of claim 1, wherein:
the tungsten carbide and the first carbon layer contact each other.

5. The tungsten carbide structure of claim 1, wherein:
the surface of tungsten carbide include a pair of surfaces vertically opposing each other and a surface forming the mesopore.

6. A method of preparing a tungsten carbide structure, the method comprising:
heat treating WO₃H₂O under ammonia gas atmosphere to prepare W₂N;
heat treating W₂N under methane gas and hydrogen gas atmospheres to prepare tungsten carbide including a carbon layer;
adding the tungsten carbide including the carbon layer and melamine in an organic solvent to form powder; and
heat treating the powder under nitrogen atmosphere to prepare a tungsten carbide structure.

7. The method of claim 6, wherein:
the forming of the powder includes stirring and drying.

8. The method of claim 6, wherein:
the preparing of the tungsten carbide structure is performed at 400 to 800 degrees Celsius.

9. The method of claim 6, wherein:
the tungsten carbide structure includes a plurality of mesopores.

10. The method of claim 9, wherein:
the tungsten carbide structure includes a plurality of carbon layers.

11. The method of claim 10, wherein:
the plurality of carbon layers contain nitrogen.
